(19) United States
(12) Patent Application Publication
(10) Pub. No.: US 2005/0281395 A1
(43) Pub. Date: Dec. 22, 2005

(54) Methods and apparatus for an interactive audio learning system

(75) Inventor: William F. Wescott, Woodinville, WA (US)

Correspondence Address: RUPAK NAG, ESQ.;Genesis LLP, Suite 18, 725 Florida St., San Francisco, CA, 94110, US

(73) Assignee: BrainOxygen, Inc.

(21) Appl. No.: 10/870,323

(22) Filed: Jun. 16, 2004

(51) Int. Cl. H04M 11/00

(52) U.S. Cl. 379/88.13; 379/88.17

(57) ABSTRACT

The present invention is an interactive audio learning system comprised of learning modules, particularly for the development of foreign language skills (e.g., vocabulary, grammar, pronunciation, dictionary). The modules are accessed via fixed or mobile telephones, with or without WAP, or devices with intelligent platforms with internet access, such as PDAs and which use voice recognition and text to voice techniques for various languages. The system can be integrated with voicemail systems, automatic telephone answering systems, and call handing systems (e.g., call centers) so that callers can be provided with an interactive mixed educational and entertainment experience instead of passively listening to music or marketing messages. The content can be aligned with the marketing objectives of a system licensee to provide the licensee with a powerful marketing tool.

### BACKGROUND OF THE INVENTION

1. Field of the Invention

The present invention relates generally to computer software and business methods relating to an interactive audio system. More specifically, it relates to an audio system for providing interactive and adaptive learning, for example, in the field of basic foreign language skills.

2. Discussion of Related Art

As those in the telephony field know, interactive services provided through telephone platforms using the telephone keypad and a human voice for input are becoming more pervasive, adding value to user services as well as providing telecommunication (“telecom”) companies with additional services and revenue streams.

Voice recognition in particular has become more common, as it is a natural and efficient way to input information. Rapid development of computing power in mobile or portable devices, in network technology, and voice recognition algorithms have made voice recognition commercially feasible. Since the mid-1990s, many well known companies have been using such systems for customer service such as information on travel, finances, and conducting commerce. Many companies are using sophisticated, interactive technology to reduce costs and increase customer satisfaction at call centers. Advanced call centers for airline and financial institutions already use voice recognition technology to provide this interaction and reduce costs. At the same time, a number of Internet-based applications have been developed whereby internet content (e.g., web pages, email) can be accessed by voice through fixed and mobile phones.

However, the vast majority of these recent applications are structured to deliver information rather than provide an interactive learning experience. They do not utilize interactive audio servers that can be linked to telephone networks.

One of the objectives of the present invention is to provide an interactive audio learning system that offers an innovative learning experience.

Another objective of the present invention is to provide an interactive audio learning system that offers educational content via the telephone, in whole or in concert with other content distribution platforms such as the Internet, an organization's intranet, or other communications devices (e.g., wireless pagers, PDAs) or with stored content (e.g., on a computer, CD-ROM, PDA).

Another objective of the present invention is to provide an interactive audio learning system that can track a user's progress and preferences so that other training and related services can be offered.

Another objective of the present invention is to provide an interactive audio learning system that offers a mix of education and entertainment (“edutainment”) as a feature integrated into voicemail systems, automatic telephone responses, call center automatic call handing (e.g., as a replacement for music while on hold), or phone based information services (e.g., current time, traffic, weather, horoscope).

Another objective of the present invention is to provide an interactive audio learning system that can provide language learning experiences with content (such as vocabulary, grammar, pronunciation, dictionary, translation) that is aligned with objectives of the entity hosting the system.

These and other objectives of the present invention are achieved with an interactive audio learning system that consists of a combination of educational modules. In a preferred embodiment, the modules enable the development of foreign language skills, including vocabulary, grammar, pronunciation, dictionary, and translation with each module developing language skills through constant testing and providing individualized feedback for correct and incorrect responses. More generally a combination of the educational modules is connected via an access mechanism that enables input from fixed and mobile phones, handheld devices such as PDAs, and other mechanisms with Internet connectivity. One of the modules is for tracking progress of the user across access platforms, another module alerts the user of new results and features, yet another module supports billing, and another enables the system administrator to modify the content, structure or functionality of the learning system.

Therefore, it would be desirable to have telephone platforms which are connected via wireless or conventional telephone networks to an interactive audio servers hosted by the telephone operator and/or other Internet connected servers which provide the interactive audio learning experience.

### SUMMARY OF THE INVENTION

In one aspect of the present invention an interactive audio learning system comprised of learning modules, particularly for the development of foreign language skills (e.g., vocabulary, grammar, pronunciation, dictionary) is described. The modules are accessed via fixed or mobile telephones, with or without WAP, or devices with intelligent platforms with internet access, such as PDAs and which use voice recognition and text to voice techniques for various languages. The system can be integrated with voicemail systems, automatic telephone answering systems, and call handing systems (e.g., call centers) so that callers can be provided with an interactive mixed educational and entertainment experience instead of passively listening to music or marketing messages. The content can be aligned with the marketing objectives of a system licensee to provide the licensee with a powerful marketing tool.

### BRIEF DESCRIPTION OF THE DRAWINGS

The invention will be better understood by reference to the following description taken in conjunction with the accompanying drawings in which:

FIG. 1 is a block diagram of an interactive audio learning system in accordance with one embodiment of the present invention;

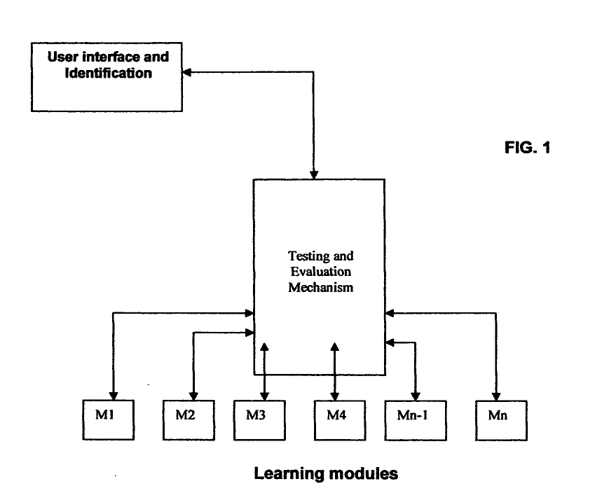

FIG. 2 a functional diagram of an interactive audio learning system in with one embodiment of the present invention.

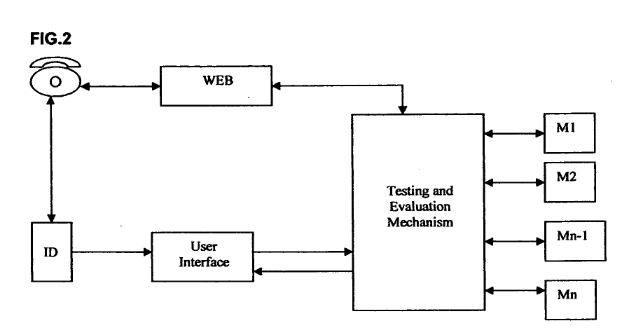

FIG. 3 is a schematic diagram of an abbreviated version of an interactive audio learning system as it relates to a full version of an interactive audio learning system in building traffic across a telephone carrier's platform in accordance with one embodiment of the present invention

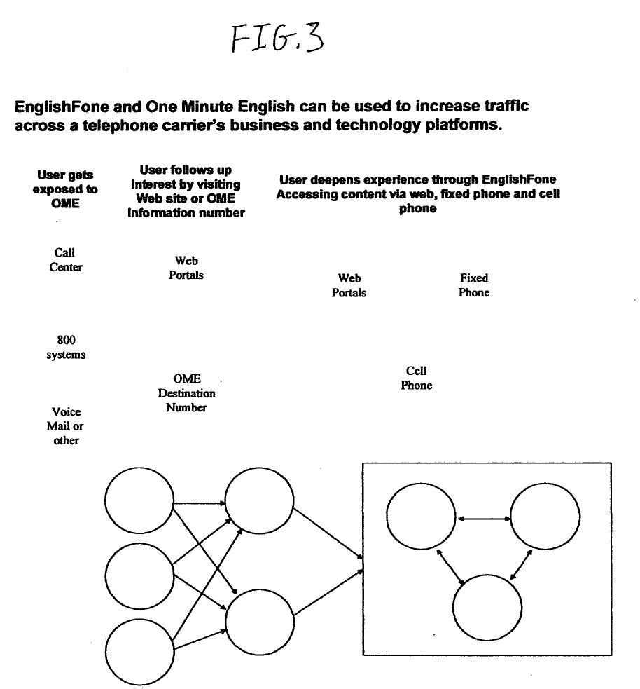

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

Currently there are over 850 million fixed phones and 450 million mobile phones as compared to around 200 million computers with Internet access. It is believed that the telephone will be the most common and widely available device with internet connectivity. As the internet grew rapidly in the 1990s with more and more valuable content and opportunities for commerce becoming available, the “voice net” is poised for similar growth.

Technologies that facilitate the use of interactive voice for learning experiences include Automatic Speech Recognition, Text to Speech (TTS) and VoiceXML. Automatic Speech Recognition (ASR) is rapidly entering the mainstream. Early speech applications recognized only a small vocabulary of 20 to 30 words, but the accuracy and vocabulary size of ASR engines has dramatically improved, fueled by refined algorithms, dramatic increases in processing power, and lower costs. Today's speech systems support naturally spoken phrases and do not require prior training.

Text to Speech enables data to be transmitted via a synthesized voice to communicate content from a variety of sources including databases, web sites, and e-mail. This technology has also improved dramatically, providing natural sounding voices in different languages and with different speech patterns and accents. Voice extensible Markup Language (VoiceXML) is the major standard for voice-based services. It allows providers to open up Web services to customers using voice interfaces. It handles synthesized speech for TTS recognition of spoken input, recognition of dual-tone multi-frequency (DTMF), recording of spoken input, and telephony call control.

Consequently, enterprises can now build automated voice services using the same technology used to create visual Web sites, thereby significantly reducing the cost of constructing an automated voice service system and delivery of the new capabilities to telephone customers. Because established Web technologies are used, the integration with back-end databases is shared with HTML applications. Just as growth of the Web was catalyzed by the development of the HTML scripting standard, the acceptance of VoiceXML as a universal standard for voice-based services is propelling the growth of voice-based services.

In accordance with the figures, an interactive audio learning system, of the present invention has a series of grammatical rules. These rules are developed through programming or using artificial intelligence computing techniques to analyze a phonetic sequence thereby identifying the semantic components of the sequence. Using these rules commands can be entered via voice (e.g., speaking the words “continue”, “stop”, “menu”, “repeat”), through the telephone keypad via dual-tone multi-frequency (DTMF), or via written text (e.g., internet browser, WAP), or via voice commands that have been processed by ASR.

The interactive audio hearing system of the present invention (the “system”) provides feedback that reinforces learning about virtually any kind of subject, providing interaction through a telephone or any apparatus that can connect to an interactive audio server. The system recognizes if a user already knows a specific element of a learning program and automatically identifies and provides material that is not yet known to the user, so that the learning experience is customized for each user and focuses on the user's specific learning needs. The system also provides user results, alerts, updates and other educational experiences that can be accessed via a variety of platforms such as telephone, fax, the Internet, short message services on mobile devices, voicemail and others.

The system allows a user to be identified by a caller id or a manual-entry id and corresponding password. The system accepts data entry via DTMF or voice and allows the user to select a specific learning module M1, . . . Mn-1, Mn. Each module has various sections, each section having one or more specific learning objectives.

As an integral part of the learning experience, the modules frequently employ evaluation or testing mechanisms. An evaluation mechanism can be implemented in various formats including multiple choice, true/false, comparison of pronunciation audio patterns, spelling over the phone, or “fill in the blank” format. In one embodiment, the evaluation mechanism is implemented through questions having various formats including those listed and with detailed feedback on answers given by users, particularly in response to incorrect answers. The evaluation mechanism varies according to the module and the one or more sections within the module and can range in format from those listed above and others. For example, the spelling tool can aid users in pronunciations and differentiating homonyms.

Each module is integrated into a distance learning, e-learning or “m-learning” program. The term “m-learning” is short-hand for “mobile learning” and essentially encompasses learning on mobile devices including mobile phones, smart phones, PDAs and others. The user can complete some sections and modules via the internet, via phone, and via other devices (e.g., handheld) with all of the results of the learning sessions available to the overall system, providing continuity across access platforms. An automatic telephone messaging system dials pre-programmed phone numbers to provide reminders to the users. If the user so chooses, she can take the lesson via the same reminder phone call.

One of the modules is a report module which sends via e-mail, internet browser, WAP or other means, results of each specific learning module. This report contains user specific feedback and suggestions for improvement and additional study, along with the user's longitudinal performance data so that trends may be identified. Performance relative to other users and reference groups is also provided.

The system includes an administration accounting module which provides statistical information on usage and results for all users. The information available includes the number of sessions taken by any given user or class of user, the amount of time spent by any given user or class of user on any give section or module, and the results for any given user or class of users for any given question or test. This allows for refinement of the methodologies for instruction and testing.

Another module is an administrative module for developing test structures for each section and module of instruction. For example, a system administrator and instructors may have controlled access to this module to add, remove or modify questions, answers and structures of the tests, as well as provide additional data for feedback on performance. The design of the testing database must be flexible so that content can be served on a variety of platforms.

Users can access a number of administrative functions through the interactive audio system of the present invention, such as performance results, account status, information on courses, and customer support. The interactive audio learning system can be linked to other systems using voice platforms such as information services, travel service and commerce and the users can be offered these links.

The interactive audio learning system provides means for distance education through platforms that do not require the use of personal computers, thereby enabling providing learning services to a wide larger population. Advantages of the interactive audio learning system include the ability to provide customized content (e.g., vocabulary, grammar, pronunciation, definitions) for specific applications (e.g,. tourism, business, banking, science) across a variety of widely available, inexpensive platforms such as fixed and mobile telephones, PDAs, WAP phones, and the Internet, allowing for “just in time” learning which often has the greatest relevance and value for users. This system can be integrated with voicemail systems, automatic telephone response systems, call center handling systems so that time users spend on hold can be a time for learning, providing additional value to the user. In addition, this provides opportunities for the host as the learning content can be aligned with marketing objectives of the host. As a marketing tool it provides callers with an interactive and educational experience which helps the service provider build an innovative, international, and customer-focused brand. The tool can be used as a waiting function (e.g., instead of music) for call centers, automated phone attendants, as a feature in voicemail products or as an information destination service similar to weather or movie information services. For example, the tool can be used as a vocabulary building lesson for in the context of an airline call center wait function wherein terms such as “check-in,” “customs,” “immigration” and “security screening” can be taught. Below is a further description that is more marketing oriented of the interactive audio hearing system in accordance with one embodiment.

One context in which the present invention can be implemented is in the telecom industry in Brazil. There is a tremendous demand to develop English skills in Brazil. In addition to the traditional ways of learning English in classrooms, recently new technologies have been developed to teach English through the Internet. The inventor of the present invention, has developed a technology known as EnglishFone to provide English training using telephone platforms. EnglishFone is a full-featured, personalized English skills development course that parallels a web-based English skills development course also available from the inventor. A user can complete modules on vocabulary, grammar and pronunciation using just a phone, or in conjunction with their English skills development through our Internet courses.

The basic approach of the EnglishFone product is building English skills through testing and feedback. This is achieved by presenting the user with different types of tests, typically multiple choice, evaluating the results and then providing specific feedback for both correct and incorrect choices. Based on the user's needs and interests, they can advance through the modules at their own pace. The modules will be customized for a telecom's needs. The proposed modules include:
1) Essential English Vocabulary—this is a 2400 word set which contains all of the essential word commonly used in standard English conversation. This word set is based on exhaustive research conducted by leading language institutes on the most commonly used vocabulary.
2) Basic Business Vocabulary—the initial version of this vocabulary module contains the 500 of the most useful business terms that a user would typically encounter. Additional terms will be added in the future.
3) Basic Travel Vocabulary—the initial version of this vocabulary module contains the 250 of the most useful travel terms that a user would typically encounter. Additional terms will be added in the future.
4) English Grammar—this module tests the user's knowledge and provides feedback in key areas including: regular verb tenses; irregular verb tenses; subject—verb agreement.
5) English Pronunciation—this modules have nearly 900 items that cover the complete English sound system of consonants, vowels, adjustments, stress and intonation. This module analyzes the user's voice and provides immediate feedback to improve the user's pronunciation.
6) English-Portuguese translation dictionary—the user will indicate what kind of vocabulary they are interested in, starting out with the business and travel vocabulary outlined in items 2 and 3 above. The user will then enter, for example, the Portuguese word of interest by touchpad or through Portuguese voice recognition. The system will then return the English translation using text to speech technology.

The inventor of the present invention has also developed a new way to provide English training using telephone platforms known as One Minute English. As described above, EnglishFone is a full featured, personalized English skills development course that parallels our web-based English skills development course. A user can complete full modules on vocabulary, grammar and pronunciation using just a phone, or in conjunction with their English skills development through our Internet courses.

One Minute English is a condensed version of EnglishFone, containing free standing modules on vocabulary, grammar and pronunciation. One Minute English is intended to work as a marketing tool, providing callers with an interactive, educational and unique experience which helps the licensee build an innovative, international, and customer-focused brand. One Minute English can be used as a waiting function (e.g., instead of music) for call centers, 0800 services, automated phone attendants, as a feature in voicemail products or as an information destination service similar to weather or movie information services.

One Minute English can be used to market EnglishFone and internet based English skills development courses through direct tie-ins. The examples used in the vocabulary, grammar, and pronunciation lessons of One Minute English can be customized to subtly market the client's products and services. Examples of vocabulary associated with a telecom's products, such as “call waiting”, “caller id”, “toll free”. One Minute English sits on the voice platform of your choice, allowing you to leverage your existing voice portal technology.

Below is an example of a script of a user interacting with the interactive audio hearing system of the present invention.

Sample Script:

[Portuguese]

Welcome to One Minute English Sponsored by [sponsor name] [e.g. Global E-Learning Solutions]. During this session, you can improve your English vocabulary, grammar and pronunciation. If you want to learn English online, go to www.companva.com.—WWW.COMPANYA.COM.

To stop at any time, say

[English]

Stop

[Portuguese]

Please press or say one of the following options:
1—beginning English
2—intermediate English
3—advanced English

[here we branch to the appropriate level, for the demo we will just have the beginning level]

Let's start with vocabulary: Press or say the correct answer number

The word “speedy” means

[Portuguese]

1 fast

2 car

3 mouse

[provide feedback and explanation for wrong answers]

To continue say

[English]

go

[Portuguese]

to stop, say

[English]

stop

[if no response or don't understand, continue to next example]

[Portuguese]

Now let's practice grammar. Press or say the correct answer number for the correct form of the verb “to be”

[English]

1 Yesterday my Internet connection is fast

2 Yesterday my Internet connection will be fast

3 Yesterday my Internet connection was fast

[provide feedback and explanation for wrong answers]

[Portuguese]

Press or say the correct answer number for the correct form of the verb “to be”

[English]

1 Today I are happy

2 Today I am happy

3 Today I are being happy

[provide feedback and explanation for wrong answers]

[Portuguese]

Now it is your turn: Let's practice English Pronunciation. Listen and then repeat the word you hear.

Practice the sound of the letter P” “Pat” [receive response][feedback][option to proceed]

Practice the sound of the letter K “cat” [receive response] [feedback] [option to proceed]

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

1. A system for communicating content, the system comprising:
learning modules accessible by a plurality of devices, wherein the devices include fixed and mobile telephones or devices with intelligent platforms with internet connectivity.

2. A system as recited in claim 1 wherein the system has voice recognition capability and text to speech capability in various languages.

3. A system as recited in claim 1 wherein the learning modules teach different foreign languages and wherein an alert module provides user alerts, an accounting module provides accounting and usage data, a content modification module provides administrators and instructors to input, remove or modify content and testing structures;

4. A system as recited in claim 1 wherein the plurality of modules has various options for user input including voice using grammatical rules developed using artificial intelligence computational techniques to analyze phonetic sequences in order to identify the underlying semantics; a telephone keypad; written text; and speech to text methods.

5. A system as recited in claim 1, further comprising a mechanism to initiate a phone call to remind a user to participate in a learning session and allow the user to initiate the learning session within the same phone call.

6. A method of increasing traffic of users across a technology platform that supports a plurality of users communicating, the method comprising:
exposing a user to one or more learning modules by accessing a communication center including a “call center,” “800 systems,” or voicemail; and
encouraging a user to further explore learning modules using one or more technology platforms including web portals, “land-line” phones, mobile phones, or other communication devices.

7. A system as recited in claim 1 that provides an opportunity to convey a marketing message of a first user to a second user, wherein the second user contacts the first user via an audio connection.
